(19) United States
(12) Patent Application Publication
(10) Pub. No.: US 2002/0189607 A1
(43) Pub. Date: Dec. 19, 2002

(54) Potato starch compositions and methods of making same

(75) Inventors: James P. Lavoie, Billerica, MA (US); Dean J. Morris, Braintree, MA (US); Noel G. Rudie, Chelmsford, MA (US); Chienkuo Ronnie Yuan, San Diego, CA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Opta Food Ingredients,Inc., Bedford, MA

(21) Appl. No.: 09/818,977

(22) Filed: Mar. 27, 2001

(51) Int. Cl. C08B 30/00

(52) U.S. Cl. 127/66

(57) ABSTRACT

Methods of making a gelatinized, shear-thinned potato starch composition, optionally comprising a lipid, is disclosed, for use in dairy applications.

### BACKGROUND OF THE INVENTION

Starch normally consists of a mixture of amylopectin and amylose. Amylopectin is a highly branched polymer of α-D glucosyl residues which are distributed in units of 15-60 residues per chain (Godet et al., 1995, Carbohydrate Polymers 27:47-52). Amylose is a mainly linear polymer of about 500-6000 α-D glucosyl residues. It is well known that amylose can form complexes with molecules such as iodine, alcohols and lipids, whereas amylopectin forms these complexes weakly or not at all (Morrison et al., 1993, Cereal Chem. 70:385-91; Sarko and Zugenmaier, 1980, Fiber Diffraction Methods, A. D. French & K. C. Gardner, eds., ACS Symposium Series 141:459-82).

The in situ biosynthesis of amylose-lipid complexes in starch with naturally occurring fatty acids and phospholipids has been demonstrated (Morrison et al., 1993, supra). Others have shown that complex formation occurs during heat/moisture treatments, especially during gelatinization of starches with the naturally containing lipids (Kugimiya et al., 1980, Starke 32:265-70; Kugimiya & Donovan, 1981, J. Food Sci. 46:765-77) or when lipids are added to defatted starches (Biliaderis et al., 1986, Food Chem. 22:279-95) or pure amylose which is free of natural lipids (Biliaderis et al., 1985, Carbohydr. Polym. 5:367-89).

Both naturally-occurring and heat-formed complexes show specific properties such as a decrease in amylose solubility or an increase in gelatinization temperatures (Eliasson et al., 1981, Starke 33:130, Morrison et al., 1993, supra). Polar lipids, e.g., fatty acids and their monoglyceride esters are of technological importance in starch systems, as they cause a reduction in stickiness, improved freeze-thaw stability (Mercier et al., 1980, Cereal Chem. 57:4-9) and retardation of retrogradation. One important example is the use of fatty acids and monoglycerides as anti-staling agents in bread and biscuits. Incorporation of such additives in the dough induces a slower crystallization (retrogradation) of the amylose fraction and retards the staling of bread (Krog, 1971, Starke 22:206-10).

### SUMMARY OF THE INVENTION

The invention provides methods of preparing a potato starch product. Potato starch is cooked to gelatinize the starch, then sheared to reduce the viscosity. The shearing of the starch reduces the viscosity sufficiently to improve heat transfer, agitation, and pumping of the gelatinized potato starch in an industrial setting.

The invention features a method of preparing a potato starch composition, comprising heating (e.g., by jet cooking) a mixture of potato starch in an aqueous medium under conditions sufficient to produce a gelatinized potato starch, and processing the gelatinized potato starch under conditions of shear to reduce the viscosity to a degree sufficient to further process the starch through processing equipment. The method can further comprise the step of debranching the resulting starch product, such as by enzymatic debranching with, for example, Pullulanase (e.g., PROMOZYME® (Novo Nordisk A/V, Denmark)). The method can also further comprise drying the potato starch composition. In a preferred embodiment, the potato starch is debranched and dried.

In another embodiment, an emulsifier can be coprocessed with the potato starch using the methods described above, to produce a starch-lipid product. Preferably, the emulsifier is a monoglyceride, e.g., MYVEROL® (Quest International, The Netherlands). The amount of the emulsifier used can be about 0.1% (w/w) to about 5.0% (w/w) of the weight of the starch, preferably about 0.2% to about 0.5%.

The invention also features potato starch compositions produced by the methods described above. The starch products disclosed herein are debranched, and possess good gel strength. The starch products also have the expected Theological properties (i. e., thickening and adhesion) for which starches have traditionally been employed, and also other properties, e.g., fat-like textures. The starch product disclosed herein may therefore be employed in any food formulation, e.g., as an opacifier, texturizing agent or to replace fat. Preferably, the starch product or the starch-lipid complex can be used in place of fat or cream in dairy formulations. The starch product has additional benefits in that it can be made Kosher for Passover, and controls syneresis in food systems containing water.

### DETAILED DESCRIPTION OF THE INVENTION

During gelatinization, potato starch becomes extremely viscous, thereby preventing further processing. This problem is not particularly evident or problematic during processing of potato starch on a small scale, e.g., at bench scale, but it is evident on an industrial scale, where the viscosity makes is difficult to further process the cooked, i.e., gelatinized, potato starch. Applicants have discovered a method for producing potato starch compositions that overcome the aforementioned viscosity problems and is compatible with industrial processing equipment.

According to the method, starch and optional lipid are combined in an aqueous medium such as water to produce a dispersion. The dispersion generally contains from about 5% to about 25% (w/w) of starch, preferably about 15% to about 20% solids by weight. The lipid, if used, will be present in an amount which is approximately about 0.1% to about 5% of the starch weight, and more preferably about 0.2% to about 0.5% of the starch weight present in the composition.

The starch used as a starting material in the process of the present invention can be a native starch or a pregelatinized starch. One of ordinary skill in the art will understand that the aqueous potato starch can be prepared in a variety of ways, e.g., the solids of the raw material can be determined using a moisture balance. One may therefore know with precision the content of the starch solids in either a dry or aqueous starch preparation.

The potato starch is then heated (e.g., jet-cooked or batch cooked) under conditions sufficient to hydrate the amylose and amylopectin present in the starch, thereby producing gelatinized potato starch. For example, this process can be done by gelatinizing (e.g., in a jet-cooker) potato starch (e.g., 10 gallons at about 15% solids) in an aqueous solution. Methods of operating cooking machinery are well known in the art, e.g., the jet-cooker maybe heated with steam to about 85° C., and a pump speed of one gallon per minute. Cooking the starch at a temperature of, e.g., 85° C. requires only a short time to gelatinize the starch, e.g., 20-30 minutes in a batch cooker for a 10 gallon batch. Processing in a jet cooker requires about 10 minutes for a 10-gallon batch at 1 gallon per minute.

If a lipid is combined with the starch this can be carried out, for example, by co-jet cooking the starch-lipid dispersion. Alternatively, the starch or starch-lipid dispersion can be heated in a reactor or batch cooker, or by any other method in which the starch is gelatinized in the presence of the lipid, such as by extrusion. The starch can also be jet cooked into the lipid, that is, the starch can be heated to or above its gelatinization temperature and immediately combined with the lipid. The lipid may need to be dispersed beforehand in a small amount of water and the dispersion added to the starch slurry prior to cooking; added to the jet cooked starch; or the starch is jet cooked into the dispersion of the lipid. The temperature and pH necessary to disperse the lipid in water are characteristic for each lipid or can be determined by those skilled in the art. It is essential that the lipid and starch be combined prior to the heating or jet cooking step or immediately after gelatinization of the starch, in order to get good mixing and a higher yield of product. Later addition of the lipid can result in a larger particle size and a gritty product due to retrogradation of the starch, but this can be controlled by increasing the temperature.

The starch is cooked until it is gelatinized. The term “gelatinization” or variants thereof, is intended to embrace the generally recognized term but also is intended to encompass the process of swelling essentially all starch granules present in the starch, thereby releasing amylose and amylopectin. For the purposes of this invention, one can determine whether the starch is sufficiently gelatinized by visual inspection of the starch. The appearance of sufficiently gelatinized starch will be relatively clear or gel-like, rather than milky or opaque. The assessment of gelatinization is generally done visually, but can also be determined by more rigorous means, e.g., by measuring the viscosity of the cooked product. A 15% starch slurry that has been gelatinized generally has a viscosity of about 250,000 to about 1,000,000 cP, while a 10% starch slurry has a viscosity over 100,000 cP.

Gelatinization of potato starch can be done at a variety of temperatures, e.g., over 60° C. Applicants have found that high temperatures (e.g., about 120° C.) need not be used, and may be undesirable. Preferably, the starch should be cooked close to its gelatinization temperature, e.g., about 63° C., rather than at higher temperatures. This will reduce the energy expenditures required in cooking and subsequent cooling of the cooked product. Furthermore, cooking the starch at temperatures greater than about 110° C. reduces the gel strength of the finished potato starch product, thereby reducing its effectiveness when used in processed dairy products, and resulting in syneresis of the processed dairy product. Cooking the starch at temperatures over about 100° C. also requires use of a pressurized system.

If a starch-lipid complex is to be formed, then higher cooking temperatures are required, e.g., about 105° C. to about 120° C., in order to melt the lipid sufficiently so that it can react with the starch and form the starch-lipid complex. Cooking at these temperatures causes a loss of gel strength, but addition of the lipid itself also causes a decrease in gel strength. One of ordinary skill in the art will know to balance the need for gel strength with the need for the properties of the starch-lipid complex (e.g., gel strength and non-sticky, mouth clearing effect), and would therefore use the starch-lipid complex in products such as sour cream or other dairy products where high gel strength is not required. Products requiring high gel strength, e.g., the dressing portion of cottage cheese, would use the starch product disclosed herein, rather than the starch-lipid complex.

After gelatinization, the cooked starch is sheared to a degree sufficient to allow further processing of the starch through equipment of the type commonly used in the food processing industry. Gelled potato starch possesses a viscosity beyond that of other starches, and gelatinized potato starch is very thick and viscous, having a consistency akin to petroleum jelly. This high viscosity makes processing very difficult or impossible at commercially viable conditions. Applicants have found that shearing of the starch after cooking sufficiently reduces the viscosity (e.g., from about 100,000-1,000,000 cP to about 1,000-10,000 cP) to allow appropriate heat transfer and agitation properties and allow processing of the gelatinized starch through industrial equipment. To reduce viscosity, the cooked starch may be thinned mechanically (i.e., not by acid treatment) by any method known in the art, e.g., a high-shear mixer or homogenizer (e.g., GAULIN®). Shear thinning is a well-known method for reducing viscosity of gelatinized potato starch, but it is also well-recognized that potato starch molecules are very large, and therefore very sensitive to shear, and shearing therefore causes disruption of the starch granular structure, resulting in a loss of gel strength. The method described herein, however, does not break covalent bonds within the starch, but mechanically breaks down the swollen (aqueous) granular structure. Importantly, when potato starch was treated by the shearing methods described herein, no significant reduction of the starch molecule was observed, and the gel strength of the final rehydrated, gelatinized, sheared and debranched product was not reduced.

When gelatinization and shearing are complete, the gelatinized, shear-thinned starch is cooled, e.g., by a method of heat exchange well-known in the art of industrial food preparation, e.g., using chilled water. The starch dispersion can be cooled slowly or rapidly to form a paste for use in food applications, or can be optionally dried to produce a powder by a number of art-recognized methods, including spray drying, belt drying, freeze drying, drum drying or flash drying. The cooked starch can be cooled slowly or quickly to form an elastic gel, or the dispersion can optionally be dried and ground, e.g., to a fine powder. The powder can be stored at room temperature, and can be rehydrated with water or another aqueous medium, preferably an aqueous medium which is appropriate for use in food and beverage formulations, under conditions of medium to high shear to give a paste of high opacity and elastic texture.

In one embodiment, after the starch or starch-lipid dispersion is heated to solubilize the amylose present in the starch, the starch is treated to release short chain amylose. As used herein, short chain amylose is defined as amylose having a degree of polymerization (DP) of from about 6 to about 500 and a molecular weight of from about 1,000 to about 80,000 which is indicative of maltodextrin. The amylopectin:amylose ratio in a given starch can be reduced by a method called “debranching.” During debranching, the branches in the amylopectin are cleaved off, eventually producing amylose. During processing, an intermediate product, “partially debranched starch”, is also produced.

Generally, release of the short chain amylose from the starch will be carried out by enzymatically debranching the starch, e.g., the starch can be debranched with (1-6)-specific glycosidic enzymes which are capable of cleaving 1,6-alpha-D-glucosidic linkages, as described above. For instance, the starch or starch-lipid dispersion can be treated with pullulanase or isoamylase, at a temperature and pH and for a time sufficient to allow the enzyme to release the short chain amylose. Generally, appropriate temperatures will range from about 25° C. to about 100° C., with from about 55° C. to about 65° C. being preferred, for a time of from about 1 hour to about 30 hours, depending on the enzyme utilized and the enzyme concentration. Furthermore, the pH of the solution will be from about 3 to about 7.5. In a particularly preferred method, the starch or starch-lipid dispersion is treated with pullulanase, e.g., PROMOZYME®, at 60° C. at pH 5 for about 4-5 hours. The optimum conditions for the enzymatic reaction will vary, with changes in parameters such as starch and enzyme concentrations, pH, temperature and other factors which can be readily determined by the skilled artisan.

The gelatinized starch is then cooled to the optimum operating temperature of the debranching enzyme to be used, e.g., about 60° C. for PROMOZYME®. By cooking the starch at a lower temperature, combined with shear thinning the cooked starch, less time and energy is required to cool the gelatinized starch to the optimal operational temperature of the debranching enzyme, for those applications that require a debranched starch product. The shear thinning of the cooked starch also allows better and more uniform mixing of debranching enzyme into the cooked product.

To add the proper amount of enzyme to ensure complete debranching, it is necessary to know the amount of starch solids in the gelatinized product. Depending on the cooking process used, there may be gain or loss of water in the gelatinized starch, and a resulting change in the percent solids of the starch. Therefore, it may be desirable to determine the solids of the gelatinized starch product, which can be done in the same manner as was done to determine the solids content of the raw starch starting material, e.g., a moisture balance.

Once the gelatinized starch has reached the operating temperature of the enzyme (e.g., about 60° C. for PROMOZYME®), the enzyme can be added. To aid in the dispersal of the enzyme, the enzyme can be added to an aliquot of water that was reserved from mixing the starch at the beginning of the process.

The enzymatic treatment is permitted to continue until the desired amount of short chain amylose is produced. Ideally, the product is fully debranched. However, limited residual branched structures may be tolerable. The progress of the enzymatic treatment may be measured by various methods. If all critical parameters have been established for achieving a particular starch composition, then the treatment may be allowed to proceed to a predetermined relative end point in time. The end point may be determined by change in viscosity of the starch dispersion, by gel permeation chromatography, by reducing group content, iodine reaction or by any other method known in the art for measuring the degree of enzymatic debranching of the starch molecule.

Although the preparation of the starch product herein uses pullulanase (E.C. 3.2.1.41; pullulan 6-glucanohydrolase, e.g., PROMOZYME®), other endo-alpha-1,6-glucanohydrolases, such as isoamylase (E.C. 3.2.1.68), or any other endo-enzyme which exhibits selectivity in cleaving the 1,6-linkages of the starch molecule, leaving the 1,4-linkages substantially intact and releasing short chain amylose, may be used.

The optimum parameters for enzyme activity will vary depending upon factors including enzyme concentration, substrate concentration, pH, temperature, the presence or absence of inhibitors and other factors. Depending on the type of enzyme, or its source, various parameters may require adjustment to achieve optimum debranching rate. In general, enzymatic debranching is carried out at the highest feasible solids content to facilitate subsequent drying of the starch while maintaining optimum debranching rates. The practitioner will recognize that a higher concentration of solids may be employed if the starch is gelatinized by a process which produces adequate mixing to uniformly blend the enzyme and the starch at higher solids. Optimum concentrations of enzyme and substrate are governed by the level of enzyme activity which will vary depending upon the enzyme source, the enzyme supplier and the concentration of the enzyme provided in commercially available batches. One of skill in the art will generally follow the manufacturer's instructions regarding temperature, pH, time, and other conditions, when using a commercially-obtained enzyme. For novel enzymes, methods of determining the optimum conditions for activity are known in the art of enzymology, and may be employed to determine the conditions for such novel enzymes, so that they may be used to produce the starch products disclosed herein.

After the desired degree of starch debranching has been reached, the enzyme may be deactivated. PROMOZYME® is rapidly deactivated at temperatures of about 80° C., therefore, the reaction may be conveniently terminated by increasing the temperature of the starch dispersion to about 80° C. for about 40 minutes. Conditions for deactivation of other enzymes (e.g., by acid pH or by high temperature) will be supplied by their manufacturers or may be determined empirically.

The effect of debranching on viscosity of the rehydrated starch product (for example, a 5% aqueous mixture, refrigerated for 24 hours) can be controlled by debranching for different amounts of time at different concentrations of enzyme. In general, depending on the enzyme level, viscosity of the debranched starch increases dramatically, through about 5 hours of treatment, when it is maximized. Viscosity then drops off with further enzymatic treatment, due to contaminating amylase activities in the enzyme (resulting in hydrolysis of the product), and retrogradation (resulting in increased opacity). Control of the debranching enzyme treatment allows some control over the aqueous gel viscosity of the finished starch product.

Both the hydrolyzed and non-hydrolyzed starch or starch-lipid dispersions can be heated to a temperature and pH and for a time sufficient to liquify the lipid, if present, i.e., a temperature above the melting point of the lipid, to produce additional starch-lipid complexes in the composition. If a debranching enzyme is used, the heat treatment may also inactivate the enzyme. In most cases, a temperature of approximately 70° C. to approximately 100° C. is sufficient to liquify the lipid within the dispersion and inactivate the enzyme, if present. The starch dispersion can be heated by a number of conventional methods, including a heat exchanger, jacketed reactor, direct steam injection or extruder.

The treated potato starch may then be dried, if it is not to be used immediately. Methods of drying such material are known in the art. For instance, the starch product may be spray-dried, drum-dried, e.g., at about 145° C. steam with a rotation of 5-10 rpm etc. The product may then be ground into a powder, e.g., using a Retsch mill with a 0.5 mm screen. The potato starch product may then be rehydrated preferably in an aqueous medium suitable for use in food or beverage formulations (e.g., milk or water), to produce an opaque gel upon refrigeration. The gel may then be used in edible formulations.

In one embodiment, the starch may also be coprocessed during cooking with an emulsifier, such as a monoglyceride (e.g., MYVEROL®), a lysolecithin, or free fatty acids (e.g., stearic acid), to produce an amylose-lipid complex. Other lipid preparations are known in the art, such as sorbitan esters, diacetyl tartaric acid esters of monoglycerides (DATEM), propylene glycol esters, polysorbates and sucrose esters of medium and long chain saturated fatty acids (e.g., having an acyl group containing more than about 10 carbon atoms), as well as saturated fatty acids (e.g., saturated fatty acids which contain from about 12 to about 18 carbons) and unsaturated fatty acids (e.g., unsaturated fatty acids which contain from about 12 to about 18 carbons, e.g., oleic and linoleic acids). For example, lipids including, but not limited to, polyethylene glycol monolaurate or glyceryl monostearate (e.g., MYVEROL®), sodium or calcium stearoyl-2-lactylate, polyoxyethylene sorbitan monostearate, sucrose monostearate and sucrose monopalmitate are suitable for use in the amylose-lipid complex of the present invention, as well as other saturated fatty acids. Methods of coprocessing the starch with emulsifiers are also provided in U.S. Pat. Nos. 5,755,890 and 6,017,388, which are incorporated herein by reference in their entirety.

For applications in dairy products, MYVEROL® should be used at a rate of about 5% (by weight) or less, preferably about 0.2% of the starch solids, so as to provide the proper gel strength for use in dairy food applications, e.g., sour cream.

In another embodiment of the invention, a starch and lipid are heated (e.g., jet-cooked or batch cooked) to produce a dispersion of gelatinized starch and lipid in which the amylose and amylopectin are solubilized. The starch is subsequently hydrolyzed to release short chain amylose, preferably using an enzymatic treatment. After hydrolysis of the starch-emulsifier solution, the solution can optionally be heated to a temperature sufficient to liquify the lipid, thereby increasing the percentage of amylose-lipid complex formed. Thereafter, the solution can be cooled to form a paste or it can optionally be dried (e.g., by spray drying, drum drying), and optionally ground into a powder.

The starch-lipid product, when produced by a process which uses a hydrolytic method, is characterized by a relatively small particle size (e.g., a weight average of 4-5μ), a short, non-elastic texture or rheology and a low water and oil binding capacity. The starch-emulsifier composition produced by cooking starch and emulsifier, without subsequent hydrolysis, is characterized as more elastic and a less opaque gel compared to the hydrolyzed product. In either process, the dried starch-emulsifier composition can be rehydrated, preferably in an aqueous medium suitable for use in food or beverage formulations (e.g., milk or water), under conditions of medium to high shear to produce an opaque gel upon refrigeration.

The starch product disclosed herein may be employed in any edible formulation, e.g., opacifier in foods and beverages such as skim milk, or as a texturizing agent to prepare dairy products with a rheology similar to sour cream, yogurt, mayonnaise and similar products, or as a fat-replacer. In a preferred embodiment, the edible formulation contains the potato starch product in place of fat or cream in dairy formulations. The potato starch product can also be used to stabilize foams, such as in the production of ice cream. The edible formulation may be liquid or dry, may be heat processed or frozen or refrigerated, and may contain other adjuncts (e.g., gums). The product may be used as a fat replacer, or to prevent syneresis in full- or reduced fat, low or non-fat dairy preparations. For instance, use of the product can provide full-fat preparations with an even creamier mouthfeel. The product can also be used to reduce the curd:dressing ratio in dairy preparations, thereby reducing costs.

In a preferred embodiment, the edible formulation is selected from sour cream, cream cheese, ice cream, spoonable and pourable salad dressing, margarine, low-fat spreads, low-fat cheeses, baked goods, breaded foods, sauces, whipped toppings, icings, puddings and custards, mayonnaise, coffee whiteners, snack dips, yogurt, frozen desserts, fudge and other confections, skim milk, cheeses, including natural, processed and imitation cheeses in a variety of forms (e.g., shredded, block, slices, grated). The potato starch product also has the advantage in that it can be made Kosher for Passover.

The starch products disclosed herein have the expected rheological properties (i.e., thickening and adhesion) for which starches have traditionally been employed, and also other properties, e.g., fat-like textures. As provided herein, the debranched potato starch generally displays an aqueous gel strength of about 400,000 cP, while the starch-lipid complex displays an aqueous gel strngth over 100,000 cP. The starch product, when used at 3.5% in a sour cream preparation, displays a gel strength of about 400,000 cP after three weeks of refrigeration.

The potato starch product may be added to the edible formulation as a powder or as a liquid dispersion, preferably an aqueous dispersion. The dispersion may be used with or without cooking, depending upon the particular food application, and the cooking may be carried out before, during or after other steps needed to formulate the food.

The starch and optional lipid can also be co-processed with hydrocolloids, gums, polymers, modified starches and combinations thereof to change the rheology or increase the water binding capacity of the starch compositions. For example, xanthan gum, alginate, carrageenan, carboxymethyl cellulose, methyl cellulose, guar gum, gum arabic, locust bean gum and combinations thereof can be added to the starch-emulsifier compositions at any time during the preparation thereof. That is, these additional optional ingredients can be jet-cooked along with the starch and optional lipid, added prior to or after the debranching step, added prior to or after the optional heating step, added to the paste composition or dry blended with the powdered composition after drying. Preferably, the hydrocolloid, gum, modified starch or polymer is added to the dispersion after the debranching step and prior to drying the composition or is dry blended with the powdered composition after the drying step.

These optional ingredients serve to change (e.g., increase or decrease) the functional properties (e.g., water binding capacity, oil binding capacity or viscosity) of the composition depending upon product end use. For example, these optional ingredients can be added to increase the overall water binding capacity of the amylose-lipid complex or change the rheology of the amylose-lipid complex.

Without wishing to be bound by theory, it is believed that the processes described herein yield compositions comprising starch possessing altered gelation properties. In general, starch swells upon contact with water, e.g., in a low- or non-fat cottage cheese salad dressing, and quickly produces a thickened suspension, and the absorption of the water by the starch is immediate at gelatinization temperature (e.g., at about 63° C. for potato starch). In contrast, the gelatinized, sheared starch product described herein behaves more like a gum, and requires time (e.g., overnight) to set (see, e.g., the sour cream product of Example 8, below).

The starch and lipid in the form of a complex are believed to have an insoluble microparticle nature which is stabilized by the interaction between amylose and lipid. The composition also comprises uncomplexed lipid, uncomplexed starch, and optionally short chain amylose if debranching and/or hydrolysis is performed. Thus, lipids capable of forming a complex with amylose are particularly preferred for use in the invention.

Terms used herein have their art-recognized meaning unless otherwise defined. The teachings of references referred to herein are incorporated herein by reference. All percentages are by weight unless otherwise specified.

The following examples are offered for the purpose of illustrating the present invention and are not to be construed to limit the scope of the present invention:

### EXAMPLES

“DE” is the percent reducing sugar contained in a sample, and is calculated as dextrose, on a dry substance basis.

To measure gel strength, a 5% aqueous solution of the starch product was prepared, and refrigerated for 20 hours. Cuttability was then measured with a BROOKFIELD® viscometer with a helipath and t-bar spindle.

### Example 1

Jet Cook Process for Starch Ingredient

Ten gallons of aqueous potato starch of 15% solids was prepared, and the pH adjusted to 5.0 with 15% H₃PO₄. About 1 liter of water was reserved from the 15% preparation, for use in later enzyme treatment.

A jet cooker was preheated to 85° C., and the slurry was pumped through the jet cooker. The pump speed was set at one gallon per minute, and about 10 minutes was required to process the starch through the cooker. The cooked starch emerged from the jet cooker as a very thick, fully gelatinized product. The cooked starch was cooled to 60° C. by chilled water controlled by a CHROMALOX® (Pittsburgh, Pa., USA) heat controller set to ˜45° C.

The gelatinized starch was then debranched. Once the gelatinized starch had been cooled to 60° C., a sample of the starch product was measured on a moisture balance. The solids content of the gelatinized starch was calculated from this reading. PROMOZYME 400® (Novo Nordisk A/S, Denmark) was dispersed into one liter of water, and added to the gelatinized starch at final rate of 4 PUN per gram, relative to the solids in the gelatinized potato starch. The enzyme was added to one liter of water that had been reserved from the initial preparation of the 15% aqueous starch slurry. The enzyme suspension was mixed into the starch, and the mixture maintained at 60° C. for 4.5 hours.

After 4.5 hours of debranching, the starch mixture was heated to 85° C., and maintained at that temperature for 30 minutes to deactivate the enzyme.

The gelatinized, debranched starch was then dried using a drum dryer preheated with 145° C. steam. The drum was rotated at 5-10 rpm. After drying, the starch was ground in a Retsch mill with a 0.5 mm screen. The resulting starch product, when rehydrated as a 5% aqueous preparation, had a DE of 5.8 and a gel strength of 650,000 cP in a 5% rehydration.

### Example 2

Effect of Temperature of Jet Cooking on Gel Strength

Potato starch at 10% solids was jet-cooked according to the method of Example 1, above, but at several different temperatures. The cooked starch product was then debranched at 60° C., as described in Example 1, for 4 hours, with PROMOZYME 200® (4 PUN/g) (“PUN”=“Pullulanase Units Novo”) and then drum dried as described above. Cooking temperatures of 70° C.-110° C. resulted in products with similar gel strengths, but gel strength dropped of when the starch was cooked at higher temperatures (e.g., 140° C. or 160° C.), as shown in Table 1, below.

TABLE 1
Effect of jet cooking temperature on gel strength.

| Jet Cooking Temperature (° C.) | Gel Strength (cP)* |
|---|---|
| 70 | 539K |
| 80 | 505K |
| 85 | 581K |
| 110 | 490K |
| 140 | 327K |
| 160 | 339K |

*“Gel Strength” is the gel strength (in cP) of a 5% aqueous preparation of the starch product.

### Example 3

Effect of Time of Enzyme Treatment on Gel Strength

Ten gallons of potato starch at 10% solids was jet cooked according to the method of Example 1, above. The cooked starch product was then debranched at 60° C., as described in Example 1, for 4 hours, with 2.5% PROMOZYME 400® (10 PUN/g) and then drum dried as described above. The results are shown in Table 2, below, and show that a DE of about 5.0 yields a gel strength of over 600,000 cP. At 22 hours' treatment, retrogradation occurs, resulting in increased opacity, and residual amylase in the enzyme further hydrolyzes the product, resulting in reduced gel strength as the amylose is cleaved into shorter chains.

TABLE 2
Effect of time on % DE and Gel Strength in cP.

| Time (hours) | % DE | Gel Strength (cP) |
|---|---|---|
| 0.00 | 0.12 | 1,550 |
| 0.25 | 2.72 | 63,850 |
| 0.50 | 3.85 | 382,000 |
| 1.50 | 4.81 | 673,000 |
| 2.50 | 5.59 | 667,500 |
| 3.50 | 6.30 | 618,000 |
| 4.50 | 6.77 | 573,000 |
| 22.00 | 8.88 | 234,000 |

### Example 4

Kettle Cook Process for Starch Ingredient

Ten gallons of aqueous potato starch of 15% solids was prepared, and the pH adjusted to 5.0 with about 60 ml of 15% H₃PO₄. The starch was added to a steam kettle, which was heated to 85° C. The starch was then held at that temperature for 30 minutes, with constant mixing. The cooked starch was then cooled to 60° C. by chilled water controlled by a CHROMALOX® heat controller set to ˜45° C.

The gelatinized starch was then debranched. Once the gelatinized starch had been cooled to 60° C., a sample of the starch product was measured on a moisture balance. The solids content of the gelatinized starch was calculated from this reading. PROMOZYME 400® ((Novo Nordisk A/S, Denmnark) was dispersed into one liter of water, and added to the gelatinized starch at final rate of 1% enzyme (w/w), relative to the solids in the gelatinized potato starch. The enzyme was mixed into the starch, and the mixture maintained at 60° C. for 4.5 hours.

After 4.5 hours of debranching, the starch mixture was heated to 85° C., and maintained at that temperature for 30 minutes to deactivate the enzyme.

The gelatinized, debranched starch was then dried on a drum dryer preheated with 145° C. steam. The dryer was rotated at 5-10 rpm. After drying, the starch was ground in a Retsch mill with a 0.5 mm screen.

The resulting starch product had a DE of 5.2 and a gel strength of 644,500 cP, showing that the methods of jet-cooking and kettle-cooking are comparable.

### Example 5

Shear Thinning of Jet-Cooked Starch Ingredient

During gelatinization, starch at a rate of 10% solids can achieve viscosities of over 150,000 cP. Shearing the starch immediately after gelatinization can reduce the viscosity. This can be accomplished in a number of ways known in the art, e.g., by passing the cooked starch through an in-line shear pump after gelatinization and before cooling. The starch can then be cooled, debranched, drum-dried, etc., as described above.

Two batches of 10% solids potato starch were gelatinized by pumping the starch slurries through jet cookers preheated to 69° C. and 86°, respectively. The 69° C. batch had an initial viscosity of 52,990 cP, and the 96° C. batch had an initial viscosity of 24,390 cP.

The two batches were each sheared with an in-line shear pump (SILVERSON®) with a recycle pump (WAUKESHA®). The shear pump product for the 69° C. batch had a single pass viscosity of 8,175 cP. The product for the 69° C. batch had a 1 gallon per minute recycled viscosity of 4,256 cP, and a 3 gallon per minute recycled viscosity of 3,730 cP. The product for the 86° C. batch had a 3 gallon per minute recycled viscosity of 1,608 cP. These results show that higher temperature and an increased number of passes results in greater shear thinning.

The gelatinized, sheared starch was then cooled to 60° C. and debranched with 8 PUN of PROMOZYME® per gram of starch solids. The starch and enzyme mixture was maintained in the kettle at 60° C. for 2.5 hours, and heat inactivated.

The gelatinized, sheared, debranched starch was then drum-dried as described above, with 145° C. steam at 10 rpm, then ground in a Retsch mill using a 0.5 mm screen. The properties of the two batches are shown in Table 3, below.

TABLE 3
DE and gel strength of starch jet-cooked at 69° C.
and 86° C. and then shear thinned.

| | 69° C. Cook | 86° C. Cook |
|---|---|---|
| DE | 4.4 | 3.87 |
| Gel Strength (cP) | 670,000 | 578,000 |

### Example 6

Shear Thinning of Kettle-Cooked Starch Ingredient

During gelatinization, starch at a rate of 10% solids can achieve viscosities of over 150,000 cP. Shearing the starch immediately after gelatinization can reduce the viscosity. This can be accomplished in a number of ways known in the art, e.g., by passing the cooked starch through an in-line shear pump after gelatinization and before cooling. The starch can then be cooled, debranched, drum-dried, etc., as described above.

A ten-gallon batch of 10% solids potato starch was prepared in water, and the pH adjusted to 5.0 with 15% H₃PO₄ (about 26 ml). The starch was added to a steam kettle, which was heated slowly over one hour to 85° C. The steam kettle included an in-line shear pump (SILVERSON®) and a recycle pump. The starch was then held at 85° C. for 15 minutes, with constant mixing. The cooked starch was then cooled to 60° C. by chilled water controlled by a CHROMALOX® heat controller set to ˜45° C.

The sheared, gelatinized starch was then debranched. The shear pump was stopped, and 2% PROMOZYME 400L® (84 ml) was added to the starch, and mixed in well. The starch-enxymne mixture was held at 60° C. for 2.5 hours, then heat-inactivated by heating to 85° C., where it was held at that temperature for 30 minutes.

The debranched, gelatinized, sheared starch was then drum-dried as described above, with 145° C. steam, and rollers rotating at 5-10 rpm. The starch was then ground in a Retsch mill using a 0.5 mm screen. The resulting starch product had a DE of 4.73 and a gel strength of 708,000 cP.

The results are shown in Table 4, blow, which shows the effects of shear thinning during gelatinization. Samples were taken as the cook temperature was ramping up.

TABLE 4
Effect of shear thinning during gelatinization.

| Time (min) | Kettle temp (° C.) | Viscosity (cP) |
|---|---|---|
| 17 | 69.2 | 18,300 |
| 28 | 74.4 | 3,038 |
| 37 | 78.5 | 1,669 |
| 60 | 84 | 980 |
| 75 | 85 | 1,048 |

### Example 7

Process for Starch-Lipid Ingredient

This process involves gelatinizing potato starch with a lipid ingredient to form an amylose-lipid complex useful in dairy applications. Ten gallons of aqueous potato starch of 15% solids was prepared, with 5 liters of the water being held in reserve for preparing other indredients (PROMOZYME® and MYVEROL® (Quest International, The Netherlands)). Four liters of the reserve water was heated to 70° C., and 7.87 grams of MYVEROL® (0.1% (w/w), relative to the starch) was added to the warm water. Once the MYVEROL® was melted, the MYVEROL®-water dispersion was added to the starch slurry, and mixed in well. The pH of the starch-lipid slurry was adjusted to 5.0 with 15% H₃PO₄.

A jet cooker was preheated to 110° C. The slurry was pumped through the jet cooker to form the gelatinized starch-lipid complex. The pump speed was set at one gallon per minute, and about 10 minutes was required to pump the starch through the cooker. The cooked starch emerged from the jet cooker as a very thick, fully gelatinized product. The cooked starch was cooled to 60° C. by chilled water controlled by a CHROMALOX® heat controller set to ˜45° C.

The gelatinized starch was then debranched. Once the gelatinized starch had been cooled to 60° C., a sample of the starch product was measured on a moisture balance. The solids content of the gelatinized starch was calculated from this reading. PROMOZYME 400® (Novo Nordisk A/S, Denmark) was dispersed into one liter of water, and added to the gelatinized starch at final rate of 1% enzyme (w/w), relative to the solids in the gelatinized potato starch. The enzyme was added to one liter of water that had been reserved from the initial preparation of the 15% aqueous starch slurry. The enzyme suspension was mixed into the starch, and the mixture maintained at 60° C. for 4.5 hours.

After 4.5 hours of debranching, the starch mixture was heated to 85° C., and maintained at that temperature for 30 minutes to deactivate the enzyme.

The gelatinized, debranched starch was then dried in a drum dryer preheated to 145° C. with steam. The drums were rotated at 5-10 rpm. After drying, the starch was ground in a Retsch mill with a 0.5 mm screen. The resulting product had a DE of 5.67, and a gel strength of 350,000 cP.

### Example 8

Low Fat Sour Cream Made with Amylose-Lipid Complex

The amylose-lipid complex was used in the preparation of four different low-fat sour cream formulations. The formulations are provided in Table 5, below. Product #1 and #2 use unsheared starch product (Preparation KP 00018), which was made as a 10% aqueous starch preparation gelatinized at 85° C., treated with 4% PROMOZYME 200®, debranched for 4 hours, deactivated at 85° C. The unsheared starch product had a gel strength of 648,500 cP. Product #3 and #4 were prepared as a starch-lipid complex, as described above.

TABLE 5
Low-fat sour cream formulations.

| Ingredients (%) | Product #1 | Product #2 | Product #3 | Product #4 |
|---|---|---|---|---|
| Skim milk | 79.00 | 78.50 | 78.50 | 78.50 |
| Cream | 15.00 | 15.00 | 15.00 | 15.00 |
| Nonfat dry milk | 3.00 | 3.00 | 3.00 | 3.00 |
| (low heat) | | | | |
| Starch KP 00018 | 3.00 | 3.50 | | |
| Amylose-lipid complex | | | 3.50 | |
| (0.1% MYVEROL ®) | | | | |
| Amylose-lipid complex | | | | 3.50 |
| (0.5% MYVEROL ®) | | | | |
| Total | 100.00 | 100.00 | 100.00 | 100.00 |
| gel strength after | 39,700 | 49,500 | 46,100 | 39,000 |
| 24 hrs. (cP) | | | | |
| sensory comments | slight | slightly | similar to | thinner |
| | starchy | thicker | Product #2 | body, |
| | flavor | body, | | clears |
| | | slight | | mouth |
| | | starchy | | quickly |
| | | flavor | | |

For each formulation, a starter culture was prepared one day in advance, e.g., 10-20 g of Chr. Hansen's DSG 2000 series DVS sour cream culture was combined with skim milk to make a 10% starter solution, which was refrigerated until needed.

The nonfat dry milk and the starch preparations were dry blended, the other ingredients added, and the mixture blended and heated to 185° C., held for 30 seconds, and homogenized, then cooled to 75° C. The mixture was then inoculated with the starter culture, placed in a 70° C. water bath, and incubated until the mixture reached pH 4.5-4.6 (about 14-18 hours). The sour cream was then stirred and homogenized to smooth, and refrigerated.

The sour cream made by formulation #2, above, made with four different starch preparations, was stored for 3 weeks and tested for gel strength (e.g., with a BROOKFIELD® viscometer), gel gradient (e.g., with a TAXT2 Texture Analyzer). The results are shown in Table 6, below. “5% gel strength” and “5% gel gradient” refer to the properties of a rehydrated 5% aqueous preparation of the product, after 20 hours of refrigeration. “3 week gel strength” and “3 week sensory body” refer to the properties of the 3.5% sour cream preparation, after 3 weeks of refrigeration.

TABLE 6
Sensory and textural characteristics of sour cream after three weeks.

| | | 5% gel | | 3 week sensory |
|---|---|---|---|---|
| | 5% gel | gradient | 3 week gel | body (1 = soft, |
| Starch | strength (cP) | (g/mm) | strength (cP) | 9 = firm) |
| KP00124B | 139,000 | 110 | 131,800 | 3 |
| KP00132E | 399,000 | 299 | 201,700 | 4 |
| KP00160E | 513,000 | 484 | 372,000 | 6 |
| KP00166 | 629,000 | 509 | 406,000 | 6.5 |

All references, patents and patent applications cited are incorporated herein by reference in their entirety. While this invention has been particularly shown and described with references to preferred embodiments thereof, it will be understood by those skilled in the art that various changes in form and details may be made therein without departing from the scope of the invention encompassed by the appended claims.

What is claimed is:

1. A method of preparing a potato starch composition, the method comprising:
(a) heating a mixture of potato starch in an aqueous medium under conditions sufficient to disrupt essentially all of the starch granules, to produce a gelatinized potato starch;
(b) processing the gelatinized potato starch under conditions of shear to reduce the viscosity to a degree sufficient to further process the starch through processing equipment; and
(c) optionally treating the potato starch composition with a debranching enzyme;
thereby producing a potato starch composition.

2. The method of claim 1, further comprising the step of debranching the product of step (b).

3. The method of claim 2, further comprising drying the potato starch composition.

4. The method of claim 1, further comprising the steps of debranching the product of step (b) to produce debranched potato starch, and drying the debranched potato starch.

5. The method of claim 1, wherein step (a) is performed by jet cooking.

6. The method of claim 1, wherein step (b) is performed by an in-line shear pump.

7. The potato starch composition produced by the method of claim 1.

8. A method of preparing a potato starch-lipid composition, the method comprising:
(a) heating a mixture of potato starch and a lipid in an aqueous medium under conditions sufficient to disrupt essentially all of the starch granules, to produce a dispersion of gelatinized potato starch and emulsifier;
(b) processing the dispersion of gelatinized potato starch and lipid under conditions of shear to reduce the viscosity to a degree sufficient to further process the starch through processing equipment; and
(c) optionally treating the potato starch composition with a debranching enzyme;
thereby producing a potato starch-lipid composition.

9. The method of claim 8, further comprising the step of debranching the product of (b).

10. The method of claim 9, further comprising drying the potato starch composition.

11. The method of claim 8, further comprising the steps of debranching the product of step (b) to produce debranched potato starch-lipid composition, and drying the debranched potato starch-lipid composition.

12. The method of claim 8, where in the lipid is selected from the group consisting of: a monoglyceride, lysolecithin, and a free fatty acid.

13. The method of claim 8, wherein the amount of the lipid used is about 0.1% (w/w) to about 5.0% (w/w) of the weight of the starch.

14. The method of claim 8, wherein the amount of the lipid used is about 0.2% (w/w) to about 0.5% (w/w) of the weight of the starch.

15. The method of claim 8, wherein step (a) is performed by jet cooking.

16. The method of claim 8, wherein step (b) is performed by an in-line shear pump.

17. The potato starch composition produced by the method of claim 8.
